(19) United States
(12) Patent Application Publication
(10) Pub. No.: US 2020/0276996 A1
(43) Pub. Date: Sep. 3, 2020

(54) SERVER IMPLEMENTING AUTOMATIC REMOTE CONTROL OF MOVING CONVEYANCE AND METHOD OF AUTOMATIC REMOTE CONTROL OF MOVING CONVEYANCE

(71) Applicant: MITSUBISHI ELECTRIC CORPORATION, Tokyo (JP)

(72) Inventor: Nicolas GRESSET, Rennes Cedex 7 (FR)

(73) Assignee: MITSUBISHI ELECTRIC CORPORATION, Tokyo (JP)

(21) Appl. No.: 16/755,833

(22) PCT Filed: Oct. 30, 2018
(86) PCT No.: PCT/JP2018/040925

§ 371 Date: Apr. 13, 2020

(30) Foreign Application Priority Data
Nov. 30, 2017 (EP) 17204595.7

(51) Int. Cl. B61L 27/00; G06K 9/00

(52) U.S. Cl. CPC B61L 27/0038; G06K 9/00805; B61L 27/0005; B61L 27/0077

(57) ABSTRACT

A moving conveyance travels on a predefined path and includes an on-board wireless radio unit and an image-capturing device so as to capture images of the predefined path ahead the moving conveyance. A server remotely controlling the moving conveyance performs: receiving from the on-board wireless radio unit images captured by the image-capturing device; analyzing the received images so as to detect presence of obstacle ahead the moving conveyance on the predefined path; and instructing the on-board wireless radio unit to stop the moving conveyance in case of obstacle presence detection. Furthermore, the server performs: determining a field of view of the received images; and increasing quantity of uplink transmission resources allocated for allowing the on-board wireless radio unit to transmit the images toward the server, when a decrease of field of view is determined.

### TECHNICAL FIELD

The present invention generally relates to a method for automatic remote control of a moving conveyance travelling on a predefined path, such as railroads, in situations in which obstacles may be unpredictably encountered on said predefined path.

### BACKGROUND ART

Moving conveyances, such as trains, can travel on predefined paths, such as railroads, without being driven by a human operator. Such moving conveyances are automatically controlled using a remote decision-making unit, such as a server, with which the moving conveyances are wirelessly communicating.

FIG. 1A schematically represents a system 100 for automatically controlling a moving conveyance MC 140 travelling on a predefined path 130, according to the prior art, in a first situation.

The aforementioned decision-making unit is a server SERV 120 connected to a plurality of wayside wireless radio units WWRU₀, WWRU₁ 110 located along the predefined path 130. The wayside wireless radio units WWRU₀, WWRU₁ 110 act as relays between the server SERV 120 and an on-board wireless radio unit OWRU 160 located in the moving conveyance MC 140. The on-board wireless radio unit OWRU 160 controls operation of the moving conveyance MC 140 according to instructions provided by the server SERV 120. The on-board wireless radio unit OWRU 160 is in charge of gathering data, more particularly position and speed of the moving conveyance MC 140 and of images of the predefined path ahead the moving conveyance MC 140, so as to enable the server SERV 120 to detect potential obstacles ahead the moving conveyance MC 140 and to enable consequently the server SERV 120 to instruct the moving conveyance MC 140 to stop before hitting the obstacle. The on-board wireless radio unit OWRU 160 obtains the images from an image-capturing device ICD 170, such as a camera or a camcorder, installed at the front of the moving conveyance MC 140. To perform obstacle detection, the server SERV 120 implements an object-detection algorithm for detecting presence of any object on the path ahead the moving conveyance MC 140, by analyzing the captured images.

The system 100 further includes a database DB 150 used to store a description of the predefined path 130. The database DB 150 is used by the server SERV 120 to determine at which speed the moving conveyance MC 140 is able to move on the predefined path 130 according to a position of said moving conveyance MC 140 on said predefined path 130. The database DB 150 further stores a brake model enabling determining within which distance the moving conveyance MC 140 is able to stop according to the speed of the moving conveyance MC 140 and potentially other parameters (weather conditions, slope of the predefined path when braking, . . . ). The database DB 150 may further store complementary data relevant for controlling speed of the moving conveyance MC 140 on the predefined path 130.

From an instant T at which the on-board wireless radio unit OWRU 160 transmits one captured image toward the server SERV 120, a time period Tul lapses, during which the on-board wireless radio unit OWRU 160 transmits the captured image and complementary data (including at least speed and position of the moving conveyance MC 140) in uplink direction toward the server SERV 120. Transmission resources are allocated by the server SERV 120 to allow performing such uplink transmission and other resources are used for other communications (e.g. with other moving conveyances or shared with other communication systems). Then a time period Tproc lapses, during which the server SERV 120 processes the captured image and the complementary data including at least speed and position of the moving conveyance MC 140) in order to detect potential presence of an object on the path ahead the moving conveyance MC 140. Then a time period Tdl lapses, during which the server SERV 120 transmits a response in downlink direction toward the on-board wireless radio unit OWRU 160, the response indicating whether or not the moving conveyance MC 140 shall stop. This process is periodically performed, according to a fixed period Tic, so as to maintain continuously a safety distance ahead the moving conveyance MC 140. The fixed period Tic thus depends on the maximum speed of the moving conveyance MC 140. It thus means that new images are available and transmitted each and every end of the fixed period Tic. It has to be noted that any captured image is thus transmitted without waiting that the response from the server SERV 120 about the analysis of the previous image(s) be received.

Let's consider herein that Dul is a distance travelled by the moving conveyance MC 140 during the time period Tul, that Dproc is a distance travelled by the moving conveyance MC 140 during the time period Tproc, that Ddl is a distance travelled by the moving conveyance MC 140 during the time period Tdl, that Dic is a distance travelled by the moving conveyance MC 140 during the time period Tic, and that Dstop is a distance travelled by the moving conveyance MC 140 during a time period Tstop needed by the moving conveyance MC 140 to effectively stop in view of its actual speed from the instant at which the stop instructions are received.

Let's further consider herein that Dobj is a distance ahead considered as clear from any obstacle presence. The distance Dobj represents a part of the path ahead that has already been checked by the server SERV 120 and that has been considered by the server SERV 120 as clear from any obstacle presence by its object-detection algorithm. The distance Dobj is defined by the field of view of the image-capturing device ICD 170 that captures the images processed by the server SERV 120, and more particularly the depth of field.

The field of view depends on predefined characteristics of image-capturing technology implemented by the image-capturing device ICD 170. In the case of a LIDAR (“Light Detection And Ranging”), scanned environment can be reconstructed in three dimensions and distance estimation with the furthest positions in the angular field of interest can thus be obtained, which defines the distance Dobj. In the case of a camera, lens system abacus provides the depth of field, which defines the distance Dobj.

The field of view further depends on actual weather conditions (rain and fog are known to reduce the field of view) at the position where the moving conveyance is located on the predefined path 130.

The distance Dobj thus decreases over time, until a new image is processed by the server SERV 120. The distance Dobj can be expressed as follows:

Dobj=Dfov−Dlast

wherein Dfov represents a distance covered by the aforementioned field of view determined for the last processed image and Dlast represents a distance travelled by the moving conveyance MC 140 since the instant at which the last processed image has been captured.

The distance Dobj shall be such that a sum of the distances Dul, Dproc, Ddl and Dstop for the next image is less than the distance Dobj. In other words, a (positive and) non-null margin M shall exist between the sum of said distances Dul, Dproc, Ddl and Dstop and said distance Dobj, since the distance Dobj is a limit beyond which the system 100 does not know whether or not an obstacle is present on the path ahead.

FIG. 1B schematically represents the system 100 for automatically controlling the moving conveyance MC 140 travelling on the predefined path 130, according to the prior art, in a second situation. In this second situation, the path ahead the moving conveyance MC 140 makes a turn. The maximum value of the distance Dobj is then shortened compared with the first situation depicted in FIG. 1A, since the aforementioned field of view is reduced due to the turn. The risk is thus that an overrun OR may theoretically appear as shown in FIG. 1B, if the moving conveyance MC 140 maintains its speed. In such a case, the moving conveyance MC 140 is requested to slow down so that no overrun OR occur, since the distance Dstop needed to stop the moving conveyance MC 140 is consequently reduced. But this behaviour is a waste of time, and therefore a loss of performance, when after all there was no obstacle ahead.

It is therefore desirable to provide a solution that allows overcoming the aforementioned drawback of the prior art, and more particularly reducing travelling time of a moving conveyance automatically controlled by a remote server without taking risks of collision in case of potential presence of an obstacle on a predefined path on which said moving conveyance travels.

It is further desirable to provide a solution that is simple and cost-effective.

### SUMMARY OF INVENTION

To that end, the present invention concerns a method for a method of automatic remote control of a moving conveyance travelling on a predefined path, the moving conveyance including an on-board wireless radio unit and an image-capturing device installed on the moving conveyance so as to capture images of the predefined path ahead the moving conveyance, wherein a server remotely controlling the moving conveyance performs: receiving from the on-board wireless radio unit images captured by the image-capturing device; analyzing the received images so as to detect presence of obstacle ahead the moving conveyance on the predefined path; and instructing the on-board wireless radio unit to stop the moving conveyance in case of obstacle presence detection. the method is such that the server further performs: determining a field of view of the received images; and increasing quantity of uplink transmission resources allocated for allowing the on-board wireless radio unit to transmit the images toward the server, when a decrease of field of view is determined. Thus, thanks the uplink resources allocation adaptation with respect to evolution of the field of view, the speed of the moving conveyance does not need to be reduced. Hence the travelling time of the moving conveyance automatically controlled by the server is reduced, without taking risks of collision in case of potential presence of an obstacle ahead on the predefined path.

According to a particular embodiment, the server increases the quantity of uplink transmission resources allocated for allowing the on-board wireless radio unit to transmit the images toward the server, by quoting extra uplink transmission resources from a pool of uplink transmission resources, and the pool of uplink transmission resources is shared by on-board wireless radio units included in respective moving conveyances managed by the server and travelling in same radio coverage. Thus, a simple and cost-effective solution is provided.

According to a particular embodiment, the server instructs the on-board wireless radio unit to decrease speed of the moving conveyance when the server fails increasing the quantity of uplink transmission resources. Thus, collision avoidance is maintained although difficulties in uplink transmission resources allocation are encountered.

According to a particular embodiment, the on-board wireless radio unit transmits actual speed S of the moving conveyance to the server as a complement to the captured images, wherein the server allocates the quantity of uplink transmission resources for allowing the on-board wireless radio unit to transmit the images toward the server so as to fulfill the following relationship:

Tul<((Dfov−Dstop)/S)−Tic−Tproc−Tdl

wherein Tul is a period to transmit one said image from the on-board wireless radio unit to the server, Dfov is the field of view, Dstop is a distance to stop the moving conveyance in view of its actual speed S, Tic is a fixed period between successive captures of images by the image-capturing device, Tproc is an upper bounded period for the server to process one image to detect obstacle presence and Tdl is an upper bounded period to transmit instructions message from the server to the on-board wireless radio unit. thus, uplink resources allocation can easily be computed and adapted.

According to a particular embodiment, the server further performs: decreasing quantity of uplink transmission resources allocated for allowing the on-board wireless radio unit to transmit the images toward the server, when an increase of field of view is determined, under a constraint that the relationship:

Tul<((Dfov−Dstop)/S)−Tic−Tproc−Tdl

remains fulfilled. Thus, usage of uplink resources is efficient.

According to a particular embodiment, the server evaluates the distance Dstop in view of the actual speed S of the moving conveyance using a braking model stored in a database. Thus, the distance Dstop and consequently the uplink resources allocation can be easily computed and adjusted to the moving conveyance's speed.

According to a particular embodiment, the on-board wireless radio unit transmits to the server actual position of the moving conveyance as a complement to the captured images, and the field of view depends on predefined characteristics of image-capturing technology implemented by the image-capturing device, and further on actual weather conditions at said position of the moving conveyance. Thus, the uplink resources allocation, and consequently the speed of the moving conveyance, are dynamically adapted to the weather conditions without requiring external assistance.

According to a particular embodiment, the server obtains indications of the actual weather conditions from a weather monitoring and forecasting service or, via the on-board wireless radio unit, from a weather monitoring station installed on-board the moving conveyance. Thus, the uplink resources allocation, and consequently the speed of the moving conveyance, are dynamically adapted to the weather conditions in an easy way.

According to a particular embodiment, the on-board wireless radio unit transmits to the server actual position of the moving conveyance as a complement to the captured images, wherein the field of view depends on predefined characteristics of image-capturing technology implemented by the image-capturing device, and further on trajectory information about the predefined path for a portion thereof ahead the moving conveyance, and the server obtains indications of the trajectory of the predefined path ahead the moving conveyance by interrogating a database storing a description of the predefined path. Thus, the uplink resources allocation, and consequently the speed of the moving conveyance, are dynamically adapted to varying surrounding items along the predefined path.

The present invention also concerns a server implementing an automatic remote control of a moving conveyance travelling on a predefined path, the moving conveyance including an on-board wireless radio unit and an image-capturing device installed on the moving conveyance so as to capture images of the predefined path ahead the moving conveyance, wherein the server implements: means for receiving from the on-board wireless radio unit images captured by the image-capturing device; means for analyzing the received images so as to detect presence of obstacle ahead the moving conveyance on the predefined path; and means for instructing the on-board wireless radio unit to stop the moving conveyance in case of obstacle presence detection. In addition, the server further implements: means for determining a field of view of the received images; and means for increasing quantity of uplink transmission resources allocated for allowing the on-board wireless radio unit to transmit the images toward the server, when a decrease of field of view is determined.

The present invention also concerns a computer program that can be downloaded from a communication network and/or stored on a non-transitory information storage medium that can be read by a processing device such as a microprocessor. This computer program comprises instructions for causing implementation of the aforementioned method, when said program is run by the processing device. The present invention also concerns a non-transitory information storage medium, storing such a computer program.

The characteristics of the invention will emerge more clearly from a reading of the following description of at least one example of embodiment, said description being produced with reference to the accompanying drawings.

### BRIEF DESCRIPTION OF DRAWINGS

FIG. 1A schematically represents a system for automatically controlling a moving conveyance travelling on a predefined path, according to the prior art, in a first situation.

FIG. 1B schematically represents the system for automatically controlling the moving conveyance travelling on the predefined path, according to the prior art, in a second situation.

FIG. 2 schematically represents an algorithm for wirelessly transmitting relevant data from a wireless radio unit on-board a moving conveyance so as to enable a server to detect presence of potential obstacles on the predefined path, according to at least one embodiment of the present invention.

FIG. 3 schematically represents an algorithm for processing the data received from a wireless radio unit on-board the moving conveyance so as to provide relevant instructions when an obstacle is present on the predefined path, according to at least one embodiment of the present invention.

FIG. 4 schematically represents an algorithm for managing uplink transmission resources for transmitting the relevant data from the wireless radio unit on-board the moving conveyance so as to enable the server to detect presence of potential obstacles on the predefined path, according to at least one embodiment of the present invention.

FIG. 5 schematically represents an architecture of a processing device of the system.

FIG. 6 schematically represents the system for automatically controlling the moving conveyance travelling on the predefined path, according to the present invention, in the second situation.

### DESCRIPTION OF EMBODIMENTS

The context of the present invention is identical to the context described in the introductive part of the present document. Namely, the server SERV 120 is connected to a plurality of wayside wireless radio units WWRU₀, WWRU₁ 110 located along the predefined path 130. The wayside wireless radio units WWRU₀, WWRU₁ 110 act as relays between the server SERV 120 and the on-board wireless radio unit OWRU 160 located in the moving conveyance MC 140. The on-board wireless radio unit OWRU 160 controls operation of the moving conveyance MC 140 according to instructions provided by the server SERV 120. The context described hereafter further comprises the database DB 150. The database DB 150 may be connected to the server SERV 120, using a wired, wireless or optical link, or may be included in the server SERV 120.

For example, the wayside wireless radio units WWRU₀, WWRU₁ 110 are access points of a telecommunication system, such as an LTE (“Long Term Evolution”) telecommunication system or the like. For example, the server SERV 120 is connected to the wayside wireless radio units WWRU₀, WWRU₁ 110 using copper wires or optical links. The moving conveyance MC 140 is for example a train and the predefined path 130 is a railroad.

It has to be noted that equivalently the on-board wireless radio unit OWRU 160 can communicate directly with the server SERV 120 using an appropriate wireless communication technology ensuring that the on-board wireless radio unit OWRU 160 remains, in view of the predefined path 130 and geographical location of the server SERV 120, within the radio coverage of the server SERV 120 and vice versa.

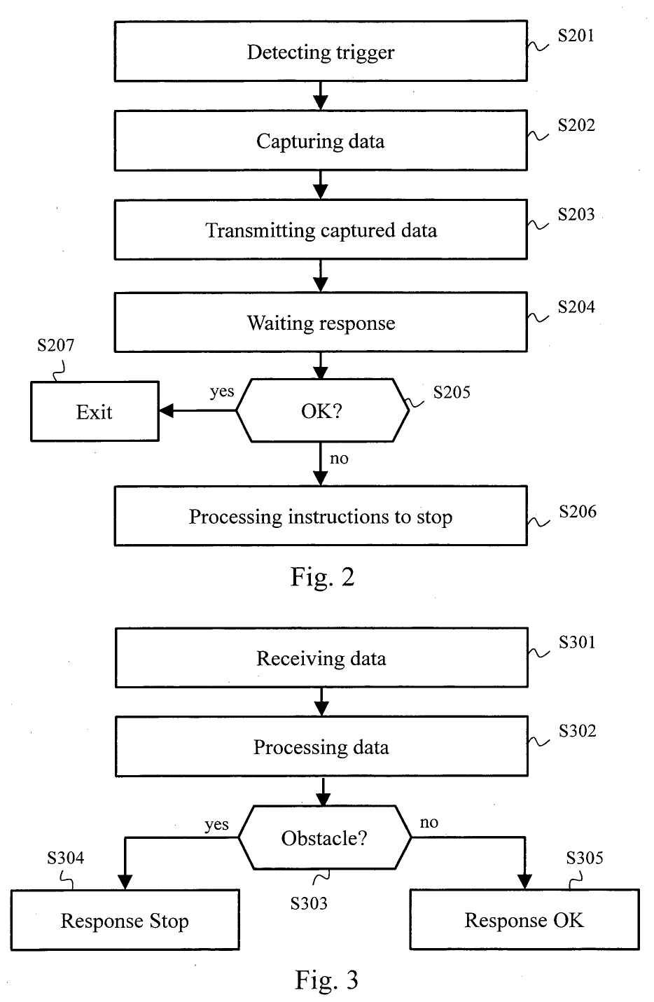

FIG. 2 schematically represents an algorithm for wirelessly transmitting relevant data from the on-board wireless radio unit OWRU 160 so as to enable the server SERV 120 to detect presence of potential obstacles on the predefined path 130, according to at least one embodiment of the present invention. The algorithm of FIG. 2 is performed by the on-board wireless radio unit OWRU 160.

In a step S201, the on-board wireless radio unit OWRU 160 detects a trigger. The trigger indicates that a new image captured by the image-capturing device ICD 170 is available. In other words, the trigger indicates that the fixed period Tic lapsed since the last capture of image by the image-capturing device ICD 170.

In a step S202, the on-board wireless radio unit OWRU 160 obtains the newly captured image from the image-capturing device ICD 170. It has to be noted that the image-capturing device ICD 170 can be connected to the on-board wireless radio unit OWRU 160 or integrated therein.

In a step S203, the on-board wireless radio unit OWRU 160 transmits the obtained newly captured image toward the server SERV 120. The wayside wireless radio units WWRU₀, WWRU₁ 110 may act as relays to provide the newly captured image toward the server SERV 120.

The on-board wireless radio unit OWRU 160 transmits complementary data in the step S203. The complementary data are at least information representative of the actual position of the moving conveyance MC 140 on the predefined path 130 and the actual speed of the moving conveyance MC 140. The actual position and/or speed of the moving conveyance MC 140 may be determined by the on-board wireless radio unit OWRU 160 thanks to a GPS (Global Positioning System) unit included therein or connected thereto. In a variant, the on-board wireless radio unit OWRU 160 obtains the speed of the moving conveyance MC 140 from a tachymeter connected thereto. In another variant, the actual position of the moving conveyance MC 140 is obtained using a beacon detector adapted for detecting beacons placed on or along the predefined path 130. In this case, the actual position of the moving conveyance MC 140 is computed by extrapolation according to the position of the last detected beacon, an instant at which said beacon has been detected, the actual instant at which the actual position of the moving conveyance MC 140 has to be determined and the speed of the moving conveyance MC 140.

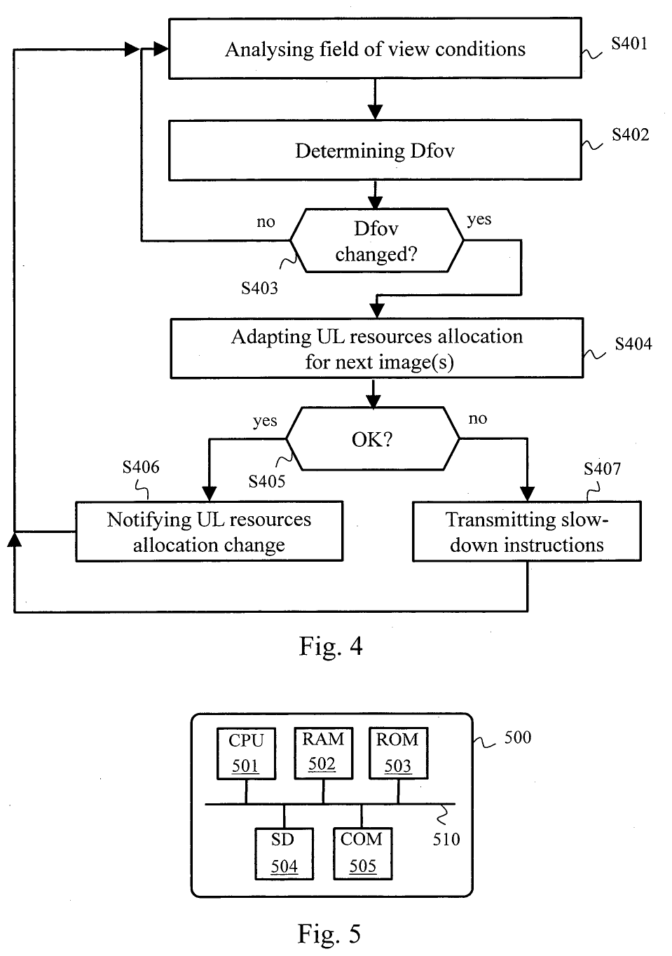

The transmission performed in the step S203 is made using uplink transmission resources allocated by the server 120. First of all, variability of the quantity of uplink transmission resources used for performing the transmissions of the step S203 can be due to variations in uplink transmission channel conditions, as usually done in wireless transmission systems, by relying for example on CSI (Channel State Information) measurements performed by the wayside wireless radio units WWRU₀, WWRU₁ 110 while the moving conveyance MC 140 is moving on the predefined path 130 and communicated and/or on a fingerprint database collecting CSI measurements made during previous journeys of moving conveyances on said predefined path 130. However, as described hereafter with respect to FIG. 4, the quantity of transmission resources allocated by the server SERV 120 to allow performing said transmissions further depends on the distance Dfov and further on the speed of the moving conveyance MC 140.

In a step S204, the on-board wireless radio unit OWRU 160 waits for a response from the server SERV 120. When the on-board wireless radio unit OWRU 160 receives the response from the server SERV 120, a step S205 is performed.

The transmission of said response is made using downlink transmission resources allocated by the server 120. However, the size of the response is negligible in view of the size of the data transmitted in the step S203, since the response only concerns instructions whether or not to stop the moving conveyance MC 140, while the data transmitted in the step S203 comprise an image, which can consist of several megabytes depending on image resolution and encoding format. Therefore, variability of the quantity of downlink transmission resources used for transmitting the response is only due to variations in downlink transmission channel conditions, which means that the period Tdl can easily be upper bounded.

In the step S205, the on-board wireless radio unit OWRU 160 checks whether or not the received response indicates that the path ahead is clear from any presence of obstacle. If the received response indicates that the path ahead is clear from any presence of obstacle, the algorithm of FIG. 2 ends in a step S207; otherwise, a step S206 is performed.

In the step S206, the on-board wireless radio unit OWRU 160 processes instructions to stop the moving conveyance MC 140. The on-board wireless radio unit OWRU 160 instructs a controller of operations of the moving conveyance MC 140 that the moving conveyance MC 140 shall brake to stop. The moving conveyance MC 140 would then be allowed to restart its travel ahead on the predefined path upon receiving corresponding instructions from the server SERV 120. Indeed, once the obstacle is removed, the image analysis performed by the server SERV 120 would result in detecting that the predefined path ahead is clear from any presence of obstacle. The server SERV 120 would then transmit instructions to the on-board wireless radio unit OWRU 160 requesting restart of the moving conveyance MC 140. This can be combined with other safety measures. This aspect is not detailed herein since it is already widely addressed in the prior art of automatic remote control of moving conveyances. Execution of the step S206 ends the algorithm of FIG. 2.

The algorithm of FIG. 2 is repeated each time one trigger indicates that the fixed period Tic lapsed since the last capture of image(s) by the image-capturing device ICD 170, in order to ensure that any presence of obstacle on the predefined path is detected on time.

FIG. 3 schematically represents an algorithm for processing the data received from the on-board wireless radio unit OWRU 160 so as to provide relevant instructions when an obstacle is present on the predefined path 130, according to at least one embodiment of the present invention. The algorithm of FIG. 3 is implemented by the server SERV 120, each time the server SERV 120 receives data as transmitted by the on-board wireless radio unit OWRU 160 in the step S203.

In a step S301, the server SERV 120 receives the data transmitted by the on-board wireless radio unit OWRU 160 in the step S203.

In a step S302, the server SERV 120 processes the data received in the step S301. More particularly, the server SERV 130 executes the object-detection algorithm onto at least one image received in the step S301, in order to detect whether or not there is any obstacle present in the field of view ahead the moving conveyance MC 140. According to a first example, the object-detection algorithm performs as disclosed in the document “SSD: Single Shot MultiBox Detector”, Wei Liu et al, European Conference on Computer Vision (ECCV), 2016. According to a second example, the object-detection algorithm performs as disclosed in the document “Fast R-CNN”, Ross Girshick, International Conference on Computer Vision, 2015, wherein R-CNN stands for Region-based Convolutional Network. According to a third example, the object-detection algorithm performs as disclosed in the document “You Only Look Once: Unified, Real-Time Object Detection”, Joseph Redmon et al, IEEE Conference on Computer Vision and Pattern Recognition (CVPR), 2016.

In a step S303, the server SERV 120 checks whether or not execution of the object-detection algorithm results in detecting presence of an obstacle ahead the moving conveyance MC 140. If such a obstacle has been detected, a step S304 is performed; otherwise, a step S305 is performed.

In the step S304, the server SERV 120 transmits a downlink response to the on-board wireless radio unit OWRU 160 in which the server SERV 120 includes instructions to stop the moving conveyance MC 140. The algorithm of FIG. 3 then ends.

In the step S305, the server SERV 120 transmits a downlink response to the on-board wireless radio unit OWRU 160 in which the server SERV 120 indicates that the predefined path 130 ahead the moving conveyance MC 140 is clear from any obstacle presence. The moving conveyance MC 140 is thus allowed to continue its travel on the predefined path 130.

FIG. 4 schematically represents an algorithm for managing uplink transmission resources for transmitting the relevant data from the on-board wireless radio unit OWRU 160 so as to enable the server SERV 120 to detect presence of potential obstacles on the predefined path 130, according to at least one embodiment of the present invention. The algorithm of FIG. 4 is implemented by the server SERV 120 once a new image has been processed by execution of the algorithm of FIG. 3 and that no obstacle has been detected in said new image.

In a step S401, the server SERV 120 performs an analysis of the field of view conditions of said new image. As far as the processing of the new image showed that no obstacle is present ahead, the field of view of said new image defines the boundary beyond which it is not certain that no obstacle is present. In other words, the field of view of the new image defines the distance Dobj for the next image. In other words, before expiration of the time period Tic since the transmission of said new image by the on-board wireless radio unit OWRU 160 toward the server SERV 120, decision about uplink transmission resources allocation shall have been made and applied by the server SERV 120.

Determining the field of view conditions may include determining the field of view by analysis of the new image. For example, by knowing the characteristics of the lens system, such as the aperture, it is possible to know the depth of the field of view from matching tables.

Determining the field of view conditions may include determining weather conditions at the position of the moving conveyance MC 140. The field of view may indeed be different according to sunny, rainy, snowy or foggy weather conditions. The server SERV 120 may obtain indications of the weather conditions from a weather monitoring and forecasting service on a weather monitoring and forecasting server to which the server SERV 120 is connected, for example provided by the Japan Meteorological Agency. In a variant, the server SERV 120 may obtain indications of the weather conditions from a weather monitoring station installed on-board the moving conveyance MC 140, via the on-board wireless radio unit OWRU 160.

The field of view conditions may include trajectory information about the predefined path 130 for a portion thereof ahead the moving conveyance MC 140. The server SERV 120 may obtain indications of the trajectory of the predefined path 130 ahead the moving conveyance MC 140 by interrogating the database DB 150. The server SERV 120 is thus able to know from the database DB 150 if there is an upcoming turn, what is the radius of said turn in this case, or if there is an item (such as a forest or a building) obstructing partly the field of view which is located along the predefined path 130, etc.

In a step S402, the server SERV 120 determines the distance Dfov from the analysis of the field of view conditions performed in the step S401, i.e. the distance Dfov which relates to the new image (and which defines a safety travelling zone for the next image so that, if an obstacle is detected in said next image, the moving conveyance MC 140 can be stopped).

In a step S403, the server SERV 120 checks whether or not the distance Dfov changed compared with previous analysis of the field of view conditions (i.e. analysis for the image immediately preceding said new image). When the distance Dfov changed (compared with the immediately preceding image), a step S404 is performed; otherwise, the step S401 is repeated. The server SERV 120 may wait that the moving conveyance MC 140 has travelled a predefined distance or that a predefined time period has elapsed before repeating the step S401.

In the step S404, the server SERV 120 attempts adapting the uplink transmission resources allocation that allow the on-board wireless radio unit OWRU 160 to transmit the data, including the images that are then analyzed by the server SERV 120 for obstacle detection, in the step S203. The uplink transmission resources allocation is adapted so as to be adequately defined before the instant at which the on-board wireless radio unit OWRU 160 would have to transmit the next image). It is reminded that variability of the quantity of uplink transmission resources used for performing the transmissions of the step S203 can further be due to variations in uplink transmission channel conditions, and that adaptation of the uplink transmission resources allocation discussed here is complementary to the adaptation of the uplink transmission resources needed by the variations in uplink transmission channel conditions.

In the case where the distance Dfov decreased (compared with the immediately preceding image), the server SERV 120 attempts increasing the uplink transmission resources allocation (for at least the next image). Extra uplink transmission resources may be quoted from a backup pool of uplink transmission resources and/or the server SERV 120 may release uplink transmission resources from other communications having a lower priority. For example, the backup pool of uplink transmission resources is a pool of uplink transmission resources shared between on-board wireless radio units located in respective moving conveyances managed by the server SERV 120 and travelling in the same radio coverage (which means that communications with said on-board wireless radio units may interfere).

The transmission of said data (including next image) by the on-board wireless radio unit OWRU 160 are consequently faster due to a higher throughput. As a consequence, the period Tul is shortened for transmitting said next image, and equivalently the distance Dul is shortened. At the same speed of the moving conveyance MC 140, collision avoidance is maintained although the distance Dfov has decreased (compared with the immediately preceding image).

In view of what precedes, in the worst case:

Dobj=Dfov−Dic

and

Dobj=Dul+Dproc+Ddl+Dstop+M

wherein Dfov is computed for said new image and the other parameters relate to the next image.

Considering that M>0, the uplink transmission resources allocation shall be performed such that:

Dul<Dfov−Dic−Dproc−Ddl−Dstop

which can be transposed in the time domain as follows:

Tul<(Dfov−Dic−Dproc−Ddl−Dstop)/S

or equivalently:

Tul<((Dfov−Dstop)/S)−Tic−Tproc−Tdl

As already mentioned, Tic is fixed and Tdl is upper bounded. Tproc can be upper bounded as well since it consists in image analysis. Dstop can be evaluated in view of the speed S of the moving conveyance MC 140 using a braking model stored in the database DB 150.

It is assumed here that between the instant at which the new image is taken and the instant at which the on-board wireless radio unit OWRU 160 receives a downlink message including instructions to stop the moving conveyance MC 140 (i.e. after a time period Tic+Tul+Tproc+Tdl), the speed S of the moving conveyance MC 140 has not changed. If the moving conveyance MC 140 has accelerated or decelerated, this can be taken into account to get a more accurate version of the distances Dic, Dproc, Ddl, and also Dstop by taking into account the speed S of the moving conveyance MC 140 at the time the on-board wireless radio unit OWRU 160 is expected to receive said downlink message including instructions to stop the moving conveyance MC 140.

Preferably, in the case where the distance Dfov increased, the server SERV 120 decreases the uplink transmission resources allocation. The extra uplink transmission resources can thus be put in the backup pool of uplink transmission resources or used by other uplink communications. Decreasing the uplink transmission resources allocation is however done under a constraint that the margin M is maintained (positive and) non-null.

In a step S405, the server SERV 120 checks whether or not the attempt of adapting the uplink transmission resources allocation performed in the step S404 is successful. For instance, the backup pool of uplink transmission resources may be empty and the server SERV 120 may not have found a solution to release uplink transmission resources from other communications, which led to a situation in which the server SERV 120 may not have been able to obtain extra resources for the uplink transmissions from the on-board wireless radio unit OWRU 160. When the attempt of adapting the uplink transmission resources allocation performed in the step S404 is successful, a step S406 is performed; otherwise, a step S407 is performed.

In the step S406, the server SERV 120 notifies the on-board wireless radio unit OWRU 160 that the uplink transmission resources allocation has changed. The server SERV 120 transmits to the on-board wireless radio unit OWRU 160 information representative of the uplink transmission resources that are henceforth allocated for performing the transmissions of the step S203. The on-board wireless radio unit OWRU 160 is then supposed to use said uplink transmission resources for performing the transmissions of the step S203 (including the next image).

In the step S407, the server SERV 120 instructs the on-board wireless radio unit OWRU 160 to slow-down the moving conveyance MC 140. This aspect is not further detailed since it matches what is actually done in the prior art (see introductive part of the present document). The server SERV 120 does so since no extra uplink transmission resources could be found to reduce the time Tul.

Once the step S406 or the step S407 is performed, the step S401 is repeated. The server SERV 120 may wait that the moving conveyance MC 140 has travelled a predefined distance or that a predefined time period has elapsed before repeating the step S401.

By applying the algorithm of FIG. 4, the server SERV 120 gives extra uplink transmission resources to the on-board wireless radio unit OWRU 160 when the distance Dfov decreases, in order to reduce the period Tul and thus allow the moving conveyance MC 140 to maintain its speed, without taking risks of collision with an obstacle ahead.

FIG. 5 schematically represents an example hardware architecture of a processing device of the system. Such a processing device can be included in the on-board wireless radio unit OWRU 160 in order to implement the algorithm and steps described hereinbefore with respect to the on-board wireless radio unit OWRU 160. Such a processing device can also be included in the server SERV 120 in order to implement the algorithms and steps described hereinbefore with respect to the server SERV 120. It can be noted that the wayside wireless radio units WWRU₀, WWRU₁ 110 may be built with the same hardware architecture.

According to the shown example of hardware architecture, the processing device 500 comprises at least the following components interconnected by a communications bus 510: a processor, microprocessor, microcontroller or CPU (Central Processing Unit) 501; a RAM (Random-Access Memory) 502; a ROM (Read-Only Memory) 503; an HDD (Hard-Disk Drive) or an SD (Secure Digital) card reader 504, or any other device adapted to read information stored on non-transitory information storage medium; a communication interface COM 505 or a set of communication interfaces.

When the hardware architecture concerns the server SERV 120, the communication interface COM 505 enables the server SERV 120 to communicate with the wayside wireless radio units WWRU₀, WWRU₁ 110. In a variant, the communication interface COM 505 enables the server SERV 120 to wirelessly communicate directly with the on-board wireless radio unit OWRU 160.

When the hardware architecture concerns the on-board wireless radio unit OWRU 160, the communication interface COM 505 enables the on-board wireless radio unit OWRU 160 to wirelessly communicate with the wayside wireless radio units WWRU₀, WWRU₁ 110. In a variant, the communication interface COM 505 enables to the on-board wireless radio unit OWRU 160 to wirelessly communicate directly with the server SERV 120.

When the hardware architecture concerns the wayside wireless radio units WWRU₀, WWRU₁ 110, the set of communication interfaces COM 505 enables the wayside wireless radio units WWRU₀, WWRU₁ 110 to communicate with the server SERV 120 on one hand and to wirelessly communicate with the on-board wireless radio unit OWRU 160 on the other hand.

CPU 501 is capable of executing instructions loaded into RAM 502 from ROM 503 or from an external memory, such as an SD card via the SD card reader 504. After the processing device 500 has been powered on, CPU 501 is capable of reading instructions from RAM 502 and executing these instructions. The instructions form one computer program that causes CPU 201 to perform some or all of the steps of the algorithms described hereinbefore.

Consequently, it is understood that any and all steps of the algorithm described herein may be implemented in software by execution of a set of instructions or program by a programmable computing machine, such as a PC (Personal Computer), a DSP (Digital Signal Processor) or a microcontroller; or else implemented in hardware by a machine or a dedicated chip or chipset, such as an FPGA (Field-Programmable Gate Array) or an ASIC (Application-Specific Integrated Circuit). In general, the server SERV 120 and the on-board wireless radio unit OWRU 160 comprise processing electronics circuitry configured for implementing the relevant steps as described herein with respect to the device in question.

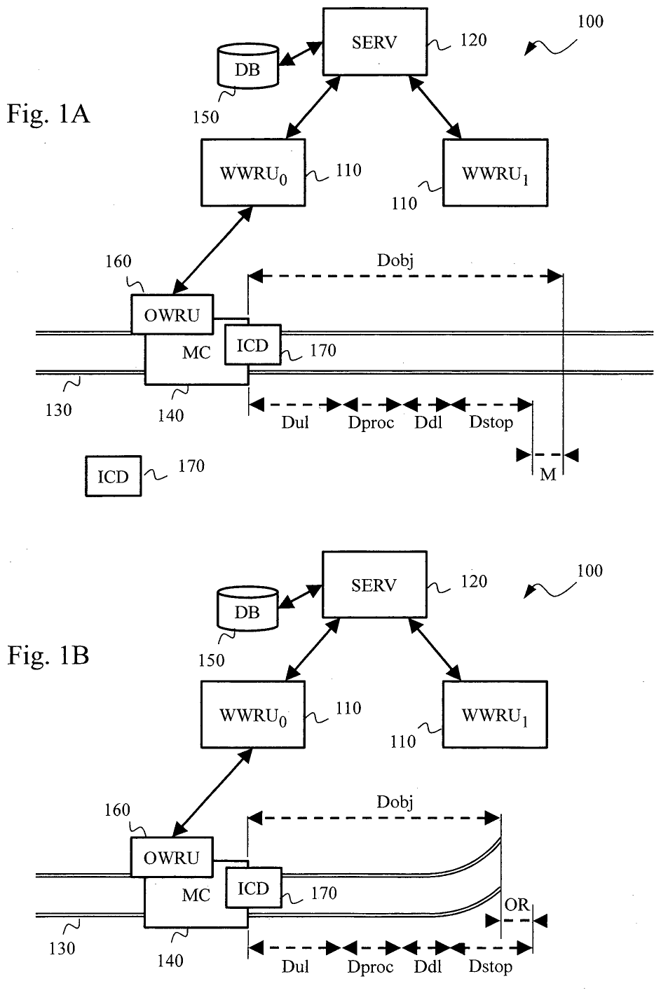

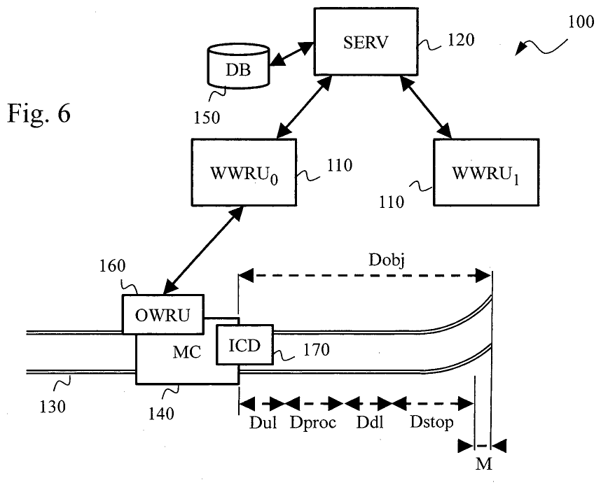

FIG. 6 schematically represents the system 100 for automatically controlling the moving conveyance MC 140 travelling on the predefined path 130, according to the present invention, in the second situation that has already been described, according to the prior art, with respect to FIG. 1B.

Since the uplink transmission resources increase has appropriately decreased the period Tul and consequently the distance Dul compared with FIG. 1B, the sum of the distances Dul, Dproc, Ddl and Dstop is equal to the distance Dobj minus the margin M, wherein the margin M is (positive and) non-null. The moving conveyance MC 140 can thus travel faster than compared with FIG. 1B, without involving more risks of collision than compared with FIG. 1B.

1. A method of automatic remote control of a moving conveyance travelling on a predefined path, the moving conveyance including an on-board transceiver and an image-capturing device installed on the moving conveyance so as to capture images of the predefined path ahead the moving conveyance, wherein a server remotely controlling the moving conveyance performs:
receiving from the on-board transceiver images captured by the image-capturing device;
analyzing the received images so as to detect presence of obstacle ahead the moving conveyance on the predefined path; and
instructing the on-board transceiver to stop the moving conveyance in case of obstacle presence detection;
characterized in that the server further performs:
determining a field of view of the received images; and
increasing quantity of uplink transmission resources allocated for allowing the on-board transceiver to transmit the images toward the server, when a decrease of field of view is determined.

2. The method according to claim 1, wherein the server increases the quantity of uplink transmission resources allocated for allowing the on-board transceiver to transmit the images toward the server, by quoting extra uplink transmission resources from a pool of uplink transmission resources, wherein the pool of uplink transmission resources is shared by on-board transceivers included in respective moving conveyances managed by the server and travelling in same radio coverage.

3. The method according to claim 1, wherein the server instructs the on-board transceiver to decrease speed of the moving conveyance when the server fails increasing the quantity of uplink transmission resources.

4. The method according to claims 1, wherein the on-board transceiver transmits actual speed S of the moving conveyance to the server as a complement to the captured images, wherein the server allocates the quantity of uplink transmission resources for allowing the on-board transceiver to transmit the images toward the server so as to fulfill the following relationship:
Tul<((Dfov−Dstop)/S)−Tic−Tproc−Tdl
wherein Tul is a period to transmit one said image from the on-board transceiver to the server, Dfov is the field of view, Dstop is a distance to stop the moving conveyance in view of its actual speed S, Tic is a fixed period between successive captures of images by the image-capturing device, Tproc is an upper bounded period for the server to process one image to detect obstacle presence and Tdl is an upper bounded period to transmit instructions message from the server to the on-board wireless radio unit transceiver.

5. The method according to claim 4, wherein the server further performs:
decreasing quantity of uplink transmission resources allocated for allowing the on-board transceiver to transmit the images toward the server, when an increase of field of view is determined, under a constraint that the relationship:
Tul<((Dfov−Dstop)/S)−Tic−Tproc−Tdl
remains fulfilled.

6. The method according to claim 4, wherein the server evaluates the distance Dstop in view of the actual speed S of the moving conveyance using a braking model stored in a database.

7. The method according to claim 1, wherein the on-board transceiver transmits to the server actual position of the moving conveyance as a complement to the captured images, wherein the field of view depends on predefined characteristics of image-capturing technology implemented by the image-capturing device, and further on actual weather conditions at said position of the moving conveyance.

8. The method according to claim 7, wherein the server obtains indications of the actual weather conditions from a weather monitoring and forecasting service or, via the on-board transceiver, from a weather monitoring station installed on-board the moving conveyance.

9. The method according to claim 1, wherein the on-board transceiver transmits to the server actual position of the moving conveyance as a complement to the captured images, wherein the field of view depends on predefined characteristics of image-capturing technology implemented by the image-capturing device, and further on trajectory information about the predefined path for a portion thereof ahead the moving conveyance, and wherein the server obtains indications of the trajectory of the predefined path ahead the moving conveyance by interrogating a database storing a description of the predefined path.

10. A computer program product comprising program code instructions that can be loaded in a programmable device for implementing the method according to claim 1, when the program code instructions are run by the programmable device.

11. A non-transitory information storage medium storing a computer program comprising program code instructions that can be loaded in a programmable device for implementing the method according to claim 1, when the program code instructions are run by the programmable device.

12. A server implementing an automatic remote control of a moving conveyance travelling on a predefined path, the moving conveyance including an on-board transceiver and an image-capturing device installed on the moving conveyance so as to capture images of the predefined path ahead the moving conveyance, wherein the server implements:
receiving from the on-board transceiver images captured by the image-capturing device;
analyzing the received images so as to detect presence of obstacle ahead the moving conveyance on the predefined path; and
instructing the on-board transceiver to stop the moving conveyance in case of obstacle presence detection;
characterized in that the server further implements:
determining a field of view of the received images; and
increasing quantity of uplink transmission resources allocated for allowing the on-board transceiver to transmit the images toward the server, when a decrease of field of view is determined.
